(19) United States
(12) Patent Application Publication
(10) Pub. No.: US 2026/0270455 A1
(43) Pub. Date: Sep. 10, 2026

(54) REFERENCE SAMPLE SELECTION IN BLOCK VECTOR GUIDED CROSS-COMPONENT PREDICTION

(71) Applicant: Nokia Technologies Oy, Espoo (FI)

(72) Inventors: Ramin GHAZNAVI YOUVALARI, Tampere (FI); Pekka ASTOLA, Tampere (FI); Jani LAINEMA, Tampere (FI)

(21) Appl. No.: 19/473,220

(22) PCT Filed: Mar. 11, 2024
(86) PCT No.: PCT/EP2024/056355

§ 371 Date: Oct. 7, 2025

Related U.S. Application Data
(60) Provisional application No. 63/494,849, filed on Apr. 7, 2023.

(51) Int. Cl. H04N 19/44; H04N 19/105; H04N 19/132

(52) U.S. Cl. CPC H04N 19/44; H04N 19/105; H04N 19/132

(57) ABSTRACT

A method comprising: receiving (1500) an image block unit of a frame, the image block unit comprising samples in color channels, wherein the color channels comprise at least one chrominance channel and one luminance channel; reconstructing (1502) samples of said luminance channels of the image block unit; determining (1504) a reference area for predicting target samples of at least one color channel of the image block unit, wherein said reference area comprises one or more of reference samples in a current or a co-located block in a current color channel/frame or in a reference color channel/frame encoded using an intra block copy (IBC) method; determining (1506) a block vector indicating a spatial distance of an area of target samples to the reference area; and predicting (1508) said target samples of at least one color channel of the image block unit using the cross-component prediction model based on the reference samples in said reference area indicated by said block vector.

### TECHNICAL FIELD

The teachings in accordance with the exemplary embodiments of this invention relate generally to at least improving block vector guided cross-component prediction, more specifically, relate to improving block vector guided cross-component prediction working with at least reference sample selection, handling of multiple block vectors in co-located area, handling of overlapping reference samples, robust reference sample selection based on co-located luminance sample values etc.,

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
AMVR adaptive motion vector resolution
BV block vector
CC cross component
CCCM cross-component linear model
CCLM cross component linear model intra prediction
CTU coding tree unit
CU central unit
IBC intra block copy
ISP intra sub-partitions
LM linear model
LMS least mean square
MRL multiple reference line
MMLM multi-model LM
MVD motion vector difference
TM template matching
VVC versatile video codec

### BRIEF DESCRIPTION OF PRIOR DEVELOPMENTS

Block vector guided cross-component prediction for video codecs uses non-local regions to improve the prediction performance of the cross-component model when intra block copy is used. If the co-located block in the reference channel is coded using intra block copy (IBC) method, the associated block vector (BV) is used for indicating the reference region for calculating the parameters of the cross-component prediction model.

When co-located region contains several blocks with associated block vectors the reference sample selection can be performed in multiple ways. Reference samples should also reflect the intensity distribution of samples in the co-located block. Poorly selected reference samples directly lead to impaired performance in cross-component prediction.

Example embodiments of this invention proposes at least improved operations for block vector guided cross-component prediction.

### SUMMARY

This section contains examples of possible implementations and is not meant to be limiting.

In an example aspect of the invention, there is an apparatus, such as a user equipment side apparatus, comprising: at least one processor; and at least one non-transitory memory storing instructions, that when executed by the at least one processor, cause the apparatus at least to: determine by a video decoder a reference sample area of a video clip sample for cross-component model derivation, wherein the determining is using an identified subset of available block vectors in one of a co-located luma coding unit or a co-located luma prediction unit, and wherein the subset is identified based on local properties; based on the determining, obtain a cross-component prediction model; and use the cross-component prediction model to decode the video clip sample.

In still another example aspect of the invention, there is a method, comprising: determining by a video decoder a reference sample area of a video clip sample for cross-component model derivation, wherein the determining is using an identified subset of available block vectors in one of a co-located luma coding unit or a co-located luma prediction unit, and wherein the subset is identified based on local properties; based on the determining, obtaining a cross-component prediction model; and using the cross-component prediction model to decode the video clip sample.

A further example embodiment is an apparatus and a method comprising the apparatus and the method of the previous paragraphs, wherein the local properties comprise at least one of a prediction unit size or prediction unit shape, wherein the at least one of a prediction unit size or shape is predetermined by the video decoder or received from a video encoder, wherein the reference sample area is an intra block copy reference area, wherein the reference sample area is determined based on more than one block area being available in at least one prediction unit of the co-located luma, wherein the determining comprises the reference sample area is derived so that overlapping areas or redundant areas are discarded, wherein an average of the available block vectors are used as a block vector pointing to the reference sample area, wherein the block vector is pointing to the reference sample area when a block vector size difference is below a threshold, wherein the average may be calculated as a weighted average based on a size of the one of a co-located luma coding unit or a co-located luma prediction unit, wherein weights are assigned to block vectors of the at least one prediction unit based on a size of a prediction unit of the at least one prediction unit, wherein the average is calculated based on a fixed grid of block vectors, wherein at least one of linear or non-linear estimation is used to derive the block vector pointing to the reference sample area, wherein based on the more than one block area, a maximum and minimum coordinate of a compound reference area defined by co-located vectors and co-located prediction unit areas is used to determine the reference sample area, wherein based on dimensions of the reference sample area being a different than the at least one prediction unit the apparatus is caused to scale a dimension of the reference sample area to match a dimension of the at least one prediction unit, wherein there is identifying temporary block vectors for co-located prediction units that do not have associated block vectors; and using the temporary block vectors to determine at least one of a reference sample area or block vectors obtained directly from co-located prediction units, wherein a spatial location of block vectors in a co-located area of the one of a co-located luma coding unit or a co-located luma prediction unit is used to interpolate or estimate a block vector pointing to reference sample of the reference sample area for the cross-component model derivation, wherein based on multiple block vectors being available in the co-located prediction unit areas, a template matching-based refinement mechanism is used to find at least one of a matching reference area block or a corresponding block vector of the identified subset of available block vectors, wherein the template matching-based refinement mechanism uses at least one sample of at least one of a co-located reference area block or at least one neighboring reference sample in a current block, wherein based on multiple block vectors being available in the co-located prediction unit areas, a chroma prediction unit is divided into multiple cross-component models based on spatial location of the said co-located prediction unit, wherein a block vector 0 is used to derive a cross-component model of an upper half of a chroma prediction unit marked with 0 and use a block vector 1 to derive a cross-component model for a lower half of a chroma prediction unit marked with 1, wherein based on multiple block vectors being available in the co-located prediction unit areas, multiple predictions are made of multiple cross-component models using multiple block vectors; and a final prediction is obtained by combining the multiple predictions, wherein weights for combining the multiple predictions can be one of defined in codec specifications or an identifier index of weights signalled to the video decoder, or calculated in the decoder side based on block information comprising reconstructed samples and a block size, wherein statistics of a co-located block of the more than one block area are used for pruning training samples in a reference area block of the reference sample area pointed to by at least one block vector, wherein minimum and maximum intensity values of samples in co-located block are determined and used for pruning in such a way that samples in a minimum intensity range and a maximum intensity range are considered for at least one of parameter calculation or training a cross-component prediction model, wherein the minimum intensity values and the maximum intensity values are extended by a delta value from the lower bound and upper bound of the maximum intensity range to provide a larger range for training, and wherein the delta value is one of fixed or is determined by the minimum intensity values and the maximum intensity values, wherein the cross-component model type is determined based on the distribution of samples from the co-located block and or reference block pointed by the block vector, wherein for a case a ratio of samples for models based on the classification parameter is distributed, a multi-model variant is determined for the cross-component prediction model, wherein said ratio of samples is one of pre-defined or signalled to the decoder, wherein the model type is determined by other parameters in addition to or instead of minimum and maximum values, wherein the other parameters comprises a mean value of samples used, wherein the mean value comprises lower and upper bounds based on intensity distance that is used for the parameter calculation, and wherein the intensity distance is one of pre-defined or signalled to the decoder, wherein based on multiple block vectors being available in the co-located prediction unit area, a reference block for model derivation is determined by finding a matching area to a co-located block in a reference channel, and/or wherein, one or more of correlation metrics are used for selecting samples from the reference sample area that a block vector of a co-located prediction unit is pointing at.

A non-transitory computer-readable medium storing program code, the program code executed by at least one processor to perform at least the method as described in the paragraphs above.

In yet another example aspect of the invention, there is an apparatus comprising: means for determining by a video decoder a reference sample area of a video clip sample for cross-component model derivation, wherein the determining is using an identified subset of available block vectors in one of a co-located luma coding unit or a co-located luma prediction unit, and wherein the subset is identified based on local properties; means, based on the determining, for obtaining a cross-component prediction model; and means for using the cross-component prediction model to decode the video clip sample.

In accordance with the example embodiments as described in the paragraph above, at least the means for determining and obtaining comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1A shows locations of the samples used for the derivation of α and β;

FIG. 1B shows a derivation of chroma prediction mode from luma mode when cclm_is enabled;

FIG. 1C shows a unified binarization table for chroma prediction mode;

FIG. 2 shows a Classification of luma samples into two classes used in the derivation of two sets of α and β, (Top) the sample domain, (bottom) the spatial domain;

FIG. 3 shows locations of the samples used for the derivation of CCCM filter when six reference lines are used;

FIG. 4 shows from left: 3-tap vertical, 3-tap horizontal, 5-tap cross, 25-tap diamond;

FIG. 5 shows an example of four reference lines neighboring to a prediction block;

FIG. 6 shows a matrix weighted intra prediction process;

FIG. 7 shows HoG computation from a template of width 3 pixels;

FIG. 8 shows a low-Frequency Non-Separable Transform (LFNST) process;

FIG. 9A shows a transform selection table;

FIG. 9B shows an intra template matching search area used;

FIG. 11 shows a reference area for IBC when CTU (m, n) is coded;

FIG. 12A and FIG. 12B show an illustration of BV adjustment for (a) horizontal flip as shown in FIG. 12A, and (b) vertical flip as shown in FIG. 12B, respectively;

FIG. 13 a chroma PU and co-located luma PUs;

FIG. 14A shows two block vectors from co-located coding units C and TL pointing to different reference sample areas. The overlapping area (marked with a pattern) will be considered only once; and

FIG. 14B shows two block vectors from co-located coding units C and TL pointing to maximum and minimum coordinates of a compound reference area defined by the co-located block vectors and co-located PU areas are used to determine the reference area.

FIG. 15 shows two block vectors from co-located prediction units C and TL pointing to different reference sample areas. The chroma PU can be divided into two cross-component models (0 and 1) based on the spatial location of the PUs to which the block vectors (bv 0 and bv 1) belong;

FIG. 16 shows a block diagram of one possible and non-limiting exemplary system in which the example embodiments may be practiced; and

FIG. 17 shows a method in accordance with example embodiments of the invention which may be performed by an apparatus, such as an apparatus as shown in FIG. 16.

### DETAILED DESCRIPTION

In example embodiments of this invention there is proposed at least a method and apparatus for at least improving block vector guided cross-component prediction. The improvements deal with reference sample selection, handling of multiple block vectors in co-located area, handling of overlapping reference samples, robust reference sample selection based on co-located luminance sample values.

As similarly stated above, hybrid video codecs, for example ITU-T H.263, H.264/AVC and HEVC, may encode the video information in two phases. At first, pixel values in a certain picture are (or “block”) are predicted for example by motion compensation means (finding and indicating an area in one of the previously coded video frames that corresponds closely to the block being coded) or by spatial means (using the pixel values around the block to be coded in a specified manner). In the first phase, predictive coding may be applied, for example, as so-called sample prediction and/or so-called syntax prediction.

In the sample prediction, pixel or sample values in a certain picture area or “block” are predicted. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction or MCP) involve finding and indicating an area in one of the previously encoded video frames that corresponds closely to the block being coded. Inter prediction may reduce temporal redundancy.

Intra prediction, where pixel or sample values can be predicted by spatial mechanisms, involve finding and indicating a spatial region relationship. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

In the syntax prediction, which may also be referred to as parameter prediction, syntax elements and/or syntax element values and/or variables derived from syntax elements are predicted from syntax elements (de) coded earlier and/or variables derived earlier. Non-limiting examples of syntax prediction are provided below.

In motion vector prediction, motion vectors e.g. for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The block partitioning, e.g. from CTU to CUs and down to PUs, may be predicted.

In filter parameter prediction, the filtering parameters e.g. for sample adaptive offset may be predicted.

Prediction approaches using image information from a previously coded image can also be called as inter prediction methods which may also be referred to as temporal prediction and motion compensation.

Prediction approaches using image information within the same image can also be called as intra prediction methods.

Secondly, the prediction error, i.e. the difference between the predicted block of pixels and the original block of pixels, is coded. This may be done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size of transmission bitrate).

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, a picture is divided into a mesh of rectangles, for each of which a similar block in one of the reference pictures is indicated for inter prediction. The location of the prediction block is coded as a motion vector that indicates the position of the prediction block relative to the block being coded.

In under developing Versatile Video Codec (VVC), there are the following new coding tools. (More description will be added later in the final patent draft if needed)
Intra prediction:
   67 intra mode with wide angles mode extension
   Block size and mode dependent 4 tap interpolation filter
   Position dependent intra prediction combination (PDPC)
   Cross component linear model intra prediction (CCLM)
   Multi-reference line intra prediction
   Intra sub-partitions
   Weighted intra prediction with matrix multiplication;
Inter-picture prediction:
   Block motion copy with spatial, temporal, history-based, and pairwise average merging candidates
   Affine motion inter prediction
   sub-block based temporal motion vector prediction
   Adaptive motion vector resolution
   8×8 block-based motion compression for temporal motion prediction
   High precision ( 1/16 pel) motion vector storage and motion compensation with 8-tap interpolation filter for luma component and 4-tap interpolation filter for chroma component
   Triangular partitions
   Combined intra and inter prediction
   Merge with MVD (MMVD)
   Symmetrical MVD coding
   Bi-directional optical flow
   Decoder side motion vector refinement
   Bi-prediction with CU-level weight;
Transform, quantization and coefficients coding:
   Multiple primary transform selection with DCT2, DST7 and DCT8
   Secondary transform for low frequency zone
   Sub-block transform for inter predicted residual
   Dependent quantization with max QP increased from 51 to 63
   Transform coefficient coding with sign data hiding
   Transform skip residual coding;
Entropy Coding:
   Arithmetic coding engine with adaptive double windows probability update
In loop filter:
   In-loop reshaping
   Deblocking filter with strong longer filter
   Sample adaptive offset
   Adaptive Loop Filter;
Screen content coding:
   Current picture referencing with reference region restriction;
360-degree video coding:
   Horizontal wrap-around motion compensation;
High-level syntax and parallel processing:
   Reference picture management with direct reference picture list signalling
   Tile groups with rectangular shape tile groups.

### Partitioning in VVC

In VVC, each picture is divided into coding tree units (CTUs) similar to HEVC. A picture may also be divided into slices, tiles, bricks and sub-pictures. CTU may be split into smaller CUs using quaternary tree structure. Each CU may be divided using quad-tree and nested multi-type tree including ternary and binary split.

There are specific rules to infer partitioning in in picture boundaries.

The redundant split patterns are disallowed in nested multi-type partitioning.

### Cross-Component Linear Model Prediction (CCLM)

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β$$

where pred_{C}(i, j) represents the predicted chroma samples in a CU and rec_{L}′(i, j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as:
W′=W, H′=H when LM mode is applied;
W′=W+H when LM-A mode is applied;
H′=H+W when LM-L mode is applied;

The above neighbouring positions are denoted as S[0, −1] . . . . S[W′−1, −1] and the left neighbouring positions are denoted as S[−1, 0] . . . . S[−1, H′−1]. Then the four samples are selected as:
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM-A mode is applied or only the above neighbouring samples are available;
S[−1, H′/8], S[−1, 3*H′/8], S[−1, 5*H′/8], S[−1, 7*H′/8] when LM-L mode is applied or only the left neighbouring samples are available;
The four neighbouring luma samples at the selected positions are down-sampled and compared four times to find two smaller values: x0A and x1A, and two larger values: x0B and x1B. Their corresponding chroma sample values are denoted as y0A, y1A, y0B and y1B. Then xA, xB, yA and yB are derived as:

$${X}_{a} = ( {x}_{A}^{0} + {x}_{A}^{1} + 1 ) ≫ 1 ;$$

$${X}_{b} = ( {x}_{B}^{0} + {x}_{B}^{1} + 1 ) ≫ 1 ;$$

$${Y}_{a} = ( {y}_{A}^{0} + {y}_{A}^{1} + 1 ) ≫ 1 ;$$

$${Y}_{b} = ( {y}_{B}^{0} + {y}_{B}^{1} + 1 ) ≫ 1$$

Finally, the linear model parameters α and β are obtained according to the following equations.

$$α = \frac{{Y}_{α} - {Y}_{b}}{{X}_{α} - {X}_{b}}$$

$$◦ β = {Y}_{b} - α \cdot {X}_{b}$$

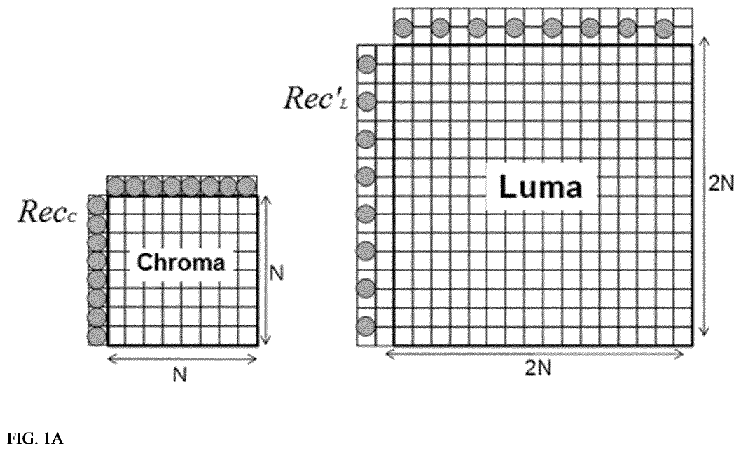

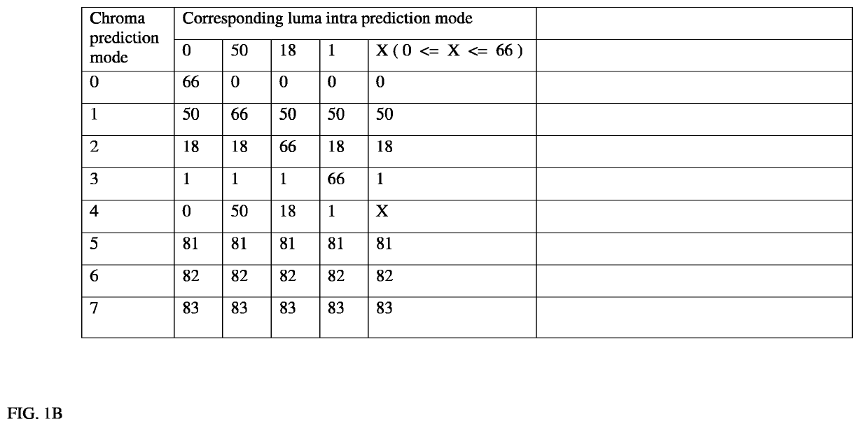

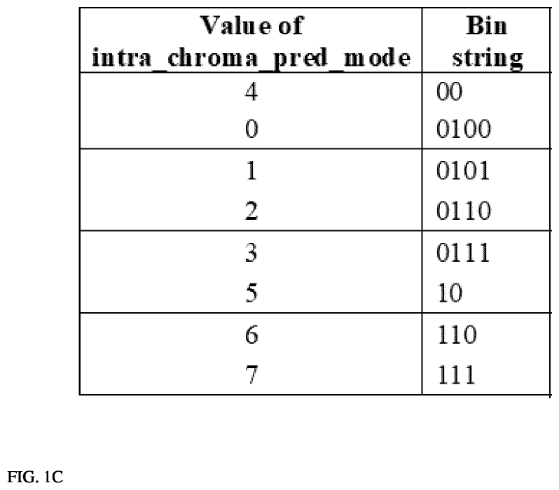

FIG. 1 shows an example of the location of the left and above samples and the sample of the current block involved in the CCLM mode.
The division operation to calculate parameter a is implemented with a look-up table. To reduce the memory required for storing the table, the diff value (difference between maximum and minimum values)
and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , , 2 , 2 , 1 , 1 , 1 , 1 , 0 \}$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H). In LM_L mode, only left template is used to calculate the linear model coefficients. To get more samples, the left template is extended to (H+W).

For a non-square block, the above template is extended to W+W, the left template is extended to H+H.

To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsmapling filters are as follows, which are corresponding to “type-0” and “type-2” content, respectively.

$${Rec}_{L}^{′} ( i , j ) = [ \begin{matrix}\begin{matrix}{rec}_{L} ( 2 i - 1 , 2 j - 1 ) + 2 \cdot {rec}_{L} ( 2 i - 1 , 2 j - 1 ) + \\ {rec}_{L} ( 2 i + 1 , 2 j - 1 ) + {rec}_{L} ( 2 i - 1 , 2 j ) +\end{matrix} \\ 2 \cdot {rec}_{L} ( 2 i , 2 j ) + {rec}_{L} ( 2 i + 1 , 2 j ) + 4\end{matrix} ] ≫ 3$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3$$

Note that only one luma line (general line buffer in intra prediction) is used to make the down-sampled luma samples when the upper reference line is at the CTU boundary.

This parameter computation is performed as part of the decoding process and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (CCLM, LM_A, and LM_L). Chroma mode signalling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

FIG. 1C shows a unified binarization table for chroma prediction mode. In FIG. 1C, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in the table are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM;
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multi-Model LM (MMLM)

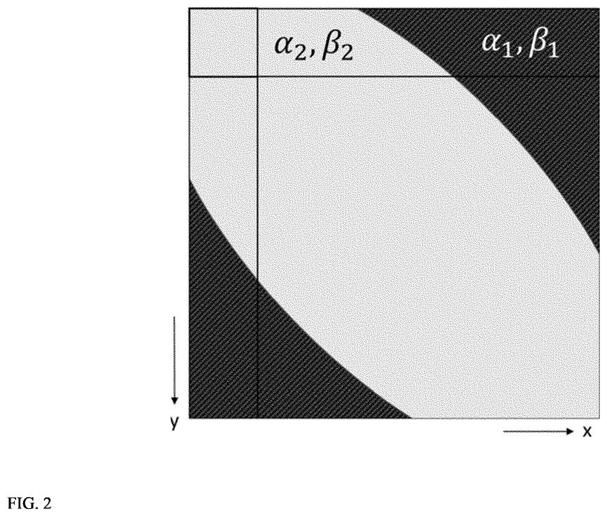

The CCLM included in VVC is extended by adding three Multi-model LM (MMLM) modes. In each MMLM mode, the reconstructed neighbouring samples are classified into two classes using a threshold which is the average of the luma reconstructed neighbouring samples. The linear model of each class is derived using the Least-Mean-Square (LMS) method. For the CCLM mode, the LMS method is also used to derive the linear model. FIG. 2 illustrates two luma-to-chroma models obtained for luma (Y) threshold of 17. FIG. 2 shows a Classification of luma samples into two classes used in the derivation of two sets of α and β, (Top) the sample domain, (bottom) the spatial domain Each luma-to-chroma model has its own linear model parameters α and β. As can be seen from the bottom figure, each luma-to-chroma model corresponds to a spatial segmentation of the content (i.e., they correspond to different objects or textures in the scene).

### Convolutional Cross-Component Model (CCCM)

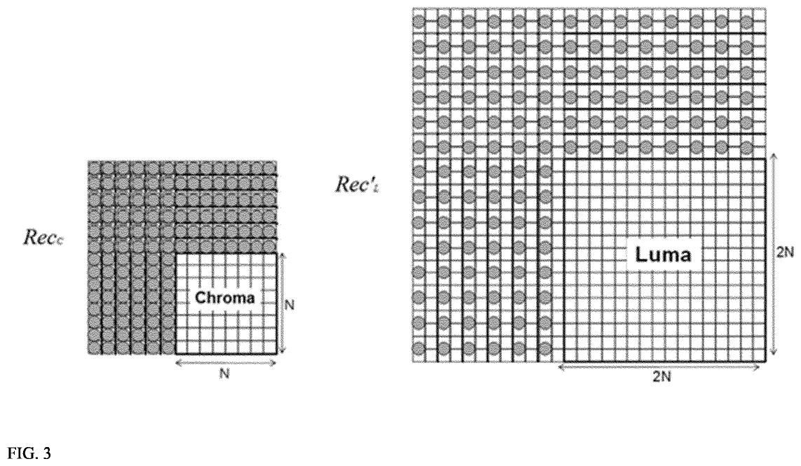

FIG. 3 shows locations of the samples used for the derivation of CCCM filter when six reference lines are used.

An improved version of cross-component prediction, known as CCCM, uses 2D filter kernel to derive the luma-to-chroma model. The filter coefficients are derived decoder-side using reconstructed set of input data and chroma samples. For the filter coefficient derivation, co-located reference sample areas (consisting of reconstructed luma and chroma samples) are defined for both luma and chroma as shown in FIG. 3 where the typically used 4:2:0 chroma down-sampling has been applied. The reference sample area for a given block can be, for example, six lines above and left as shown in FIG. 3, yet any number of reference lines (that can be realized by both the encoder and decoder) can be used. Generally, reference samples can contain any chroma and luma samples that have been reconstructed by both the encoder and decoder. Once the reference samples are determined the filter coefficients can be derived, for example, using different types of linear regression tools such as ordinary least-squares estimation, orthogonal matching pursuit, optimized orthogonal matching pursuit, ridge regression, or least absolute shrinkage and selection operator.

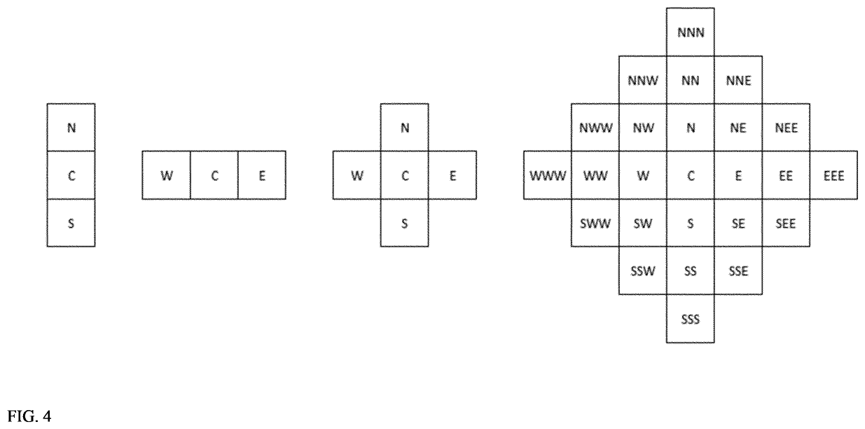

The dimensions of the filter kernel can be for example 1×3 (1D vertical), 3×1 (1D horizontal), 3×3, 7×7 or any dimensions, and can be shaped (by selecting only a subset of all possible kernel locations) as a cross or a diamond (as shown in FIG. 4) or as any given shape. FIG. 4 shows from left: 3-tap vertical, 3-tap horizontal, 5-tap cross, 25-tap diamond. When referring to the samples within the filter kernel the following notation is used: north (above), east (right), south (below), west (left) and center, as illustrated in FIG. 4 using the letters N, E, S, W, C.

The overall method of reconstructing chroma samples using convolution between a decoder-side obtained filter kernel and a set of input data is referred to as convolutional cross-component model (CCCM) here. The following steps can be applied to perform a CCCM operation:
1. Define co-located reference areas over the luma and chroma components;
2. Down-sample the luma samples to match the chroma grid (optional);
3. Scan the luma and chroma samples of the reference area and collect available statistics (such as auto-correlation matrix and cross-correlation vector) based on the filter shape;
4. Solve the filter coefficients by minimizing squared-error (or any other metric) based on the available statistics (such as the auto-correlation matrix and cross-correlation vector);
5. Calculate a predicted chroma block by convolving the down-sampled luma samples with the filter kernel.

Let us define the (possibly down-sampled) luma samples as a 2D array Y(x, y) indexed using horizontal x-coordinate and vertical y-coordinate. Let us also define the co-located chroma samples as a 2D array C(x, y) and the filter kernel (i.e., coefficients) as 3×3 array F(i, j). On a sample level we define the convolution between Y and F as,

$$C ( x , y ) = {\sum }_{j = - 1}^{j = 1} {\sum }_{i = - 1}^{i = 1} Y ( x + i , y + j ) \cdot F ( i + 1 , j + 1 ) .$$

When using other data terms, such as the non-linear square-root term, the appended convolution becomes,

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) \cdot \sqrt{Y ( x , y )} ,$$

where \hat{F} are filter coefficients that reside outside of the 2D filter kernel yet have been obtained as a part of the system of linear equations that were used to solve the 2D filter coefficients in Step 4 above. Similarly, we can add the bias term to the convolution with,

$$C ( x , y ) = ( {\sum }_{j = - 1}^{j = 1} {\sum }_{i = - 1}^{i = 1} Y ( x + i , y + j ) \cdot F ( i + 1 , j + 1 ) ) + \hat{F} ( 0 ) + \hat{F} ( 1 ) \cdot \sqrt{Y ( x , y )} .$$

### Multiple Reference Line (MRL) Intra Prediction

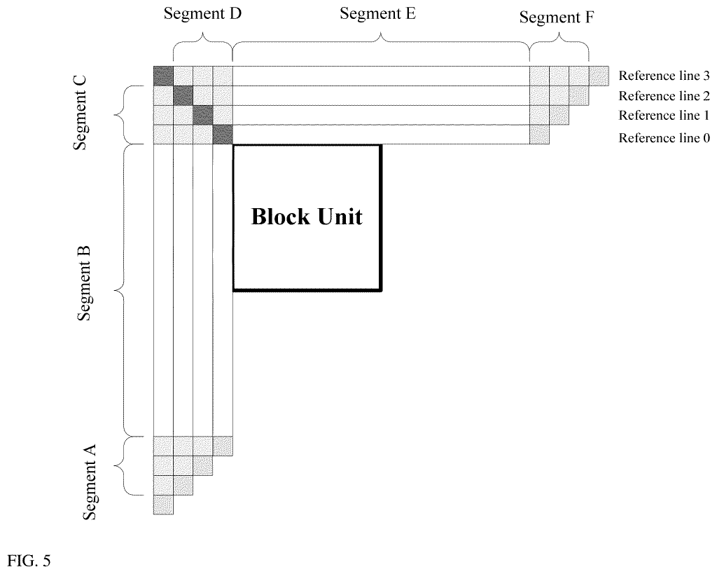

Multiple reference line (MRL) intra prediction uses more reference lines for intra prediction. FIG. 5 shows an example of four reference lines neighboring to a prediction block. In FIG. 5, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MLR to use the same 3 lines is aligned as CCLM to reduce the storage requirements for decoders.

### Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64$$

chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. All sub-partitions fulfil the condition of having at least 16 samples.

### Matrix Weighted Intra Prediction (MIP)

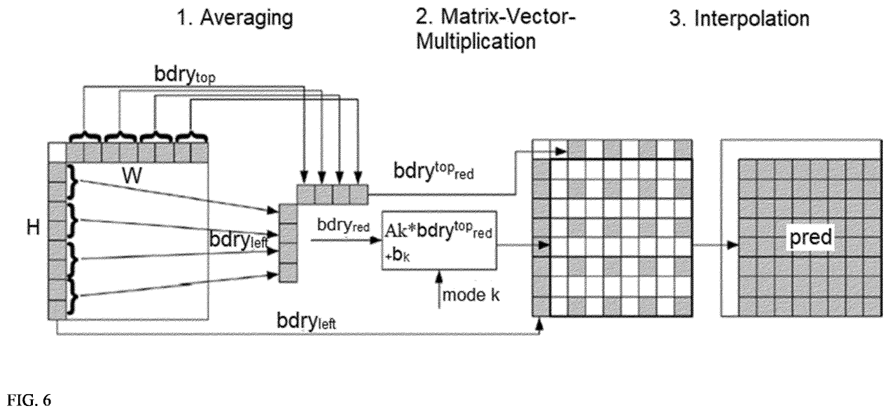

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. FIG. 6 shows a matrix weighted intra prediction process. The generation of the prediction signal is based on the following three steps, which are averaging, matrix vector multiplication and linear interpolation as shown in FIG. 6.

### Decoder Side Intra Mode Derivation (DIMD)

When DIMD is applied, two intra modes are derived from the reconstructed neighbor samples, and those two predictors are combined with the planar mode predictor with the weights derived from the gradients as described in JVET-00449. The division operations in weight derivation is performed utilizing the same lookup table (LUT) based integerization scheme used by the CCLM. For example the division operation in the orientation calculation

$$Orient = {G}_{y} / {G}_{x}$$

is computed by the following LUT-based scheme:

$$x = Floor ( Log2 ( Gx ) )$$

$$normDiff = ( ( Gx << 4 ) >> x ) \& 15$$

$$x += ( 3 + ( normDiff != 0 ) ? 1 : 0$$

$$Orient = ( Gy * ( DivSigTable [ normDiff ] \vert 8 ) + ( 1 << ( x - 1 ) ) ) >> x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

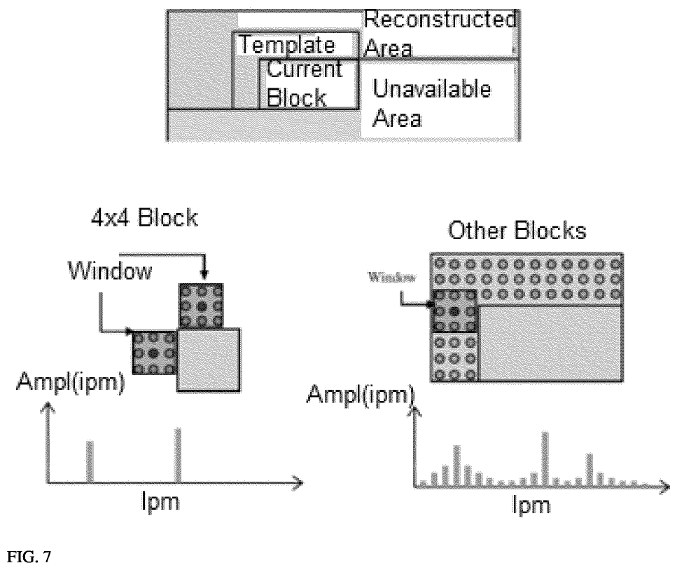

FIG. 7 shows HoG computation from a template of width 3 pixels.

### Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode2 < 2 * costMode1$$

If this condition is true, the fusion is applied, otherwise the only model is used.

Weights of the modes are computed from their SATD costs as follows:

$$weight1 = costMode2 / ( costMode1 + costMode2 ) ;$$

$$weight2 = 1 - weight1 .$$

The division operations are conducted using the same lookup table (LUT) based integerization scheme used by the CCLM.

### Low-Frequency Non-Separable Transform (LFNST)

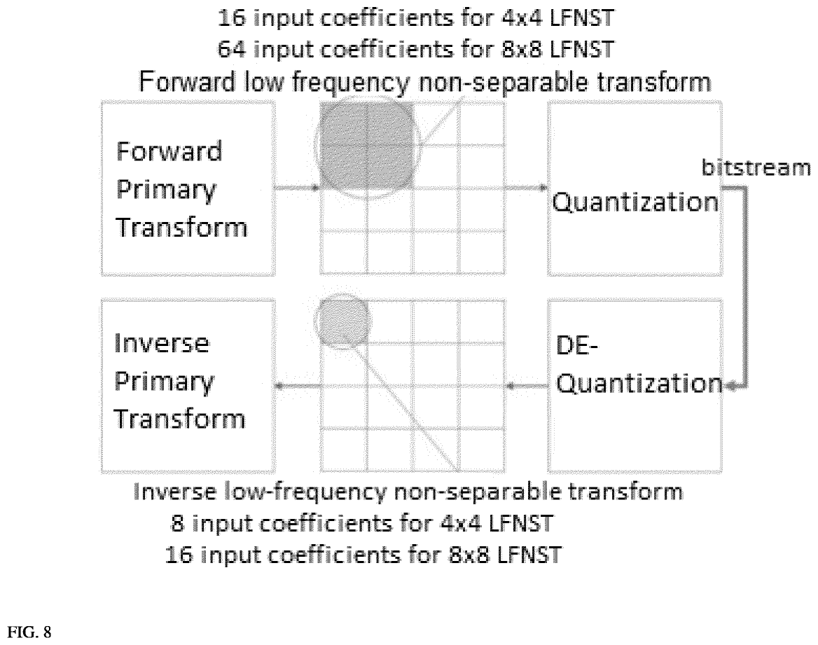

In VVC, LFNST is applied between forward primary transform and quantization (at encoder) and between de-quantization and inverse primary transform (at decoder side) as shown in FIG. 8. FIG. 8 shows a low-Frequency Non-Separable Transform (LFNST) process. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4).

Application of a non-separable transform, which is being used in LFNST, is described as follows using input as an example. To apply 4×4 LFNST, the 4×4 input block X:

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ]$$

is first represented as a vector [symbol] :

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T}$$

The non-separable transform is calculated as [symbol] =T· [symbol] , where [symbol] indicates the transform coefficient vector, and T is a 16×16 transform matrix. The 16×1 coefficient vector [symbol] is subsequently re-organized as 4×4 block using the scanning order for that block (horizontal, vertical or diagonal). The coefficients with smaller index will be placed with the smaller scanning index in the 4×4 coefficient block.

### Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${T}_{RxN} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & ⋯ & {t}_{RN}\end{matrix} ]$$

where the R rows of the transform are R bases of the N dimensional space. The inverse transform matrix for RT is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and N×4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### LFNST Transform Selection

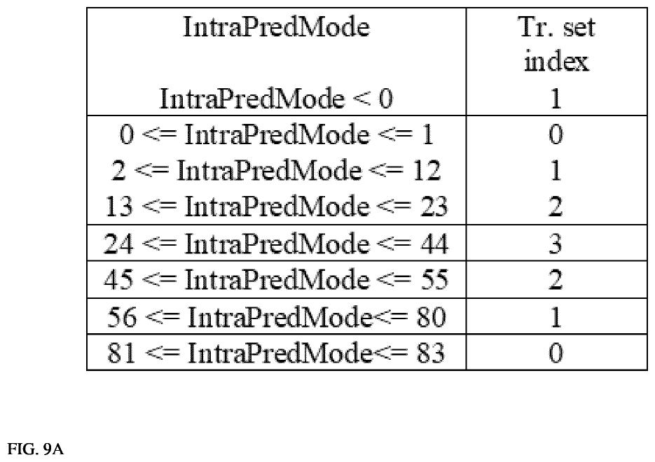

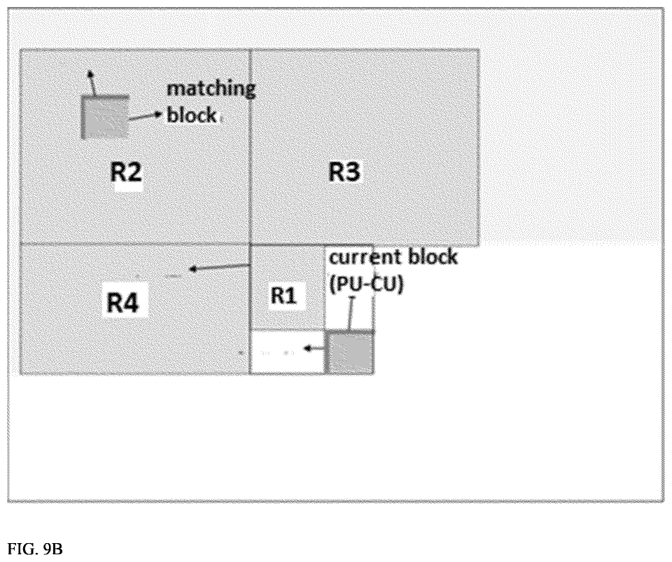

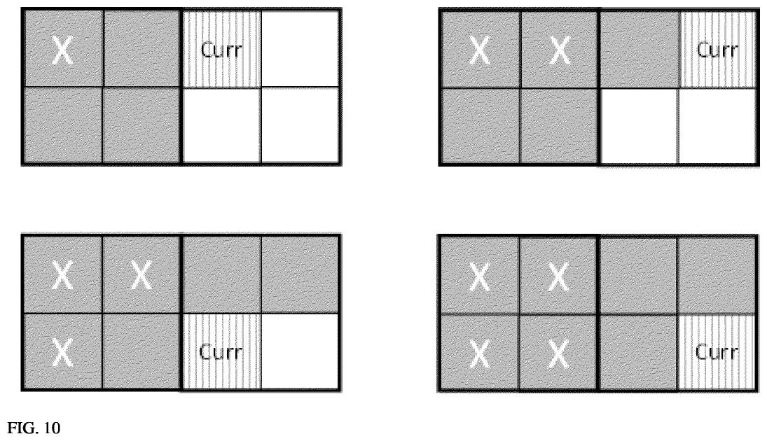

There are totally 4 transform sets and 2 non-separable transform matrices (kernels) per transform set are used in LFNST. The mapping from the intra prediction mode to the transform set is pre-defined as shown in FIG. 9A. FIG. 9A shows a transform selection table. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

FIG. 9A shows a transform selection table.

LFNST Index Signalling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both Luma and Chroma. If a dual tree is enabled, LFNST indices for Luma and Chroma are signaled separately. For inter slice (the dual tree is disabled), a single LFNST index is signaled and used for both Luma and Chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST is allowed is restricted to 64×64. Note that LFNST is enabled with DCT2 only. The LFNST index signaling is placed before MTS index signaling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### Enhanced Multiple Transform Selection (MTS) for Intra Coding

In the current VVC design, for MTS, only DST7 and DCT8 transform kernels are utilized which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:
1 candidate: sum<=th0
4 candidates: th0<sum<=th1
6 candidates: sum>th1

Note, although a total of 80 different classes are considered, some of those different classes often share exactly same transform set. So there are 58 (less than 80) unique entries in the resultant LUT.

For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

### Inter Multiple Transform Selection (MTS) Optimization

For the MTS of inter-coded CUs, four candidates: {(DST7, DST7), (DST7, DCT8), (DCT8, DST7), (DCT8, DCT8)} are used for every CU. For the larger resolution sequences (width >1080) maximum CU size for Inter-MTS usage is set to 32 (i.e., Inter-MTS is used for CU with width<=32 and height<=32), and for the remaining sequences (smaller resolution) it is set to 16. For 4-pt, 8-pt and 16-pt transforms, the current AMT transform cores, i.e., DST-7 and DCT-8, is replaced with separable KLTs, as proposed in JVET-J0021.

### Relevant Intra Block Copy and Template-Matching Based Intra Block Copy Methods:

### Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbor of the current block with another block in a predefined search area below as shown in FIG. 9B consisting of:
R1: current CTU;
R2: top-left CTU;
R3: above CTU;
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel.

That is:

$$SearchRange\_w = a * BlkW ;$$

$$SearchRange\_h = a * BlkH .$$

Where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

Intra Block Copy (IBC) with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

FIG. 10 shows an IBC reference region depending on current CU position.

### IBC Reference Area

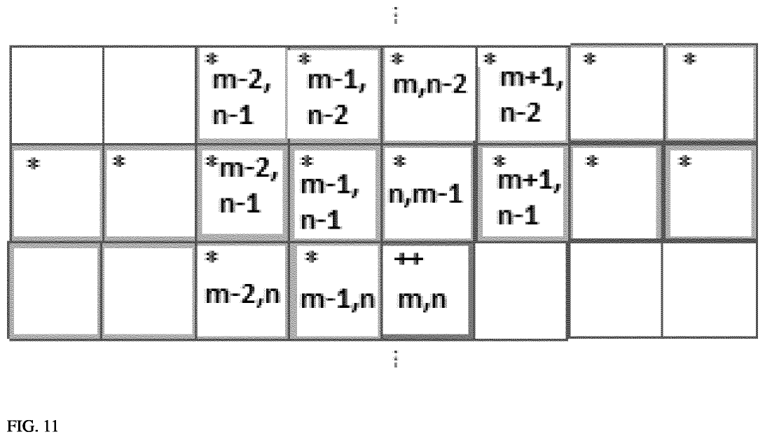

FIG. 11 shows a reference area for IBC when CTU (m, n) is coded. The blocks of FIG. 11 with a double a ++ sign at top denotes the current CTU; blocks with an asterisk * at top denotes the reference area; and the remaining blocks of FIG. 11 are invalid reference area blocks.

The reference area for IBC is extended to two CTU rows above. FIG. 11 illustrates the reference area for coding CTU (m, n). Specifically, for CTU (m, n) to be coded, the reference area includes CTUs with index (m−2, n−2) . . . (W, n−2), (0, n−1) . . . (W, n−1), (0, n) . . . (m, n), where W denotes the maximum horizontal index within the current tile, slice or picture. When CTU size is 256, the reference area is limited to one CTU row above. This setting ensure that for CTU size being 128 or 256, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

### Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

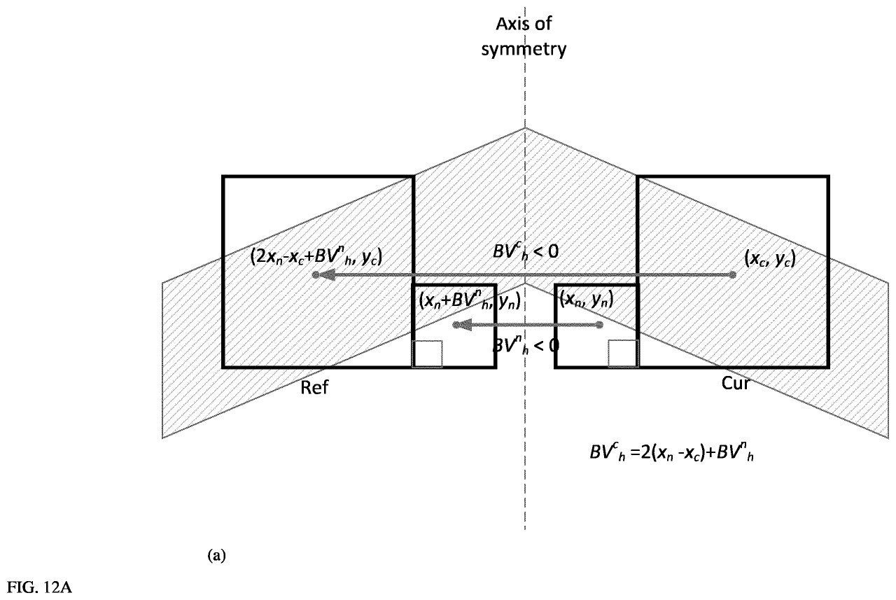

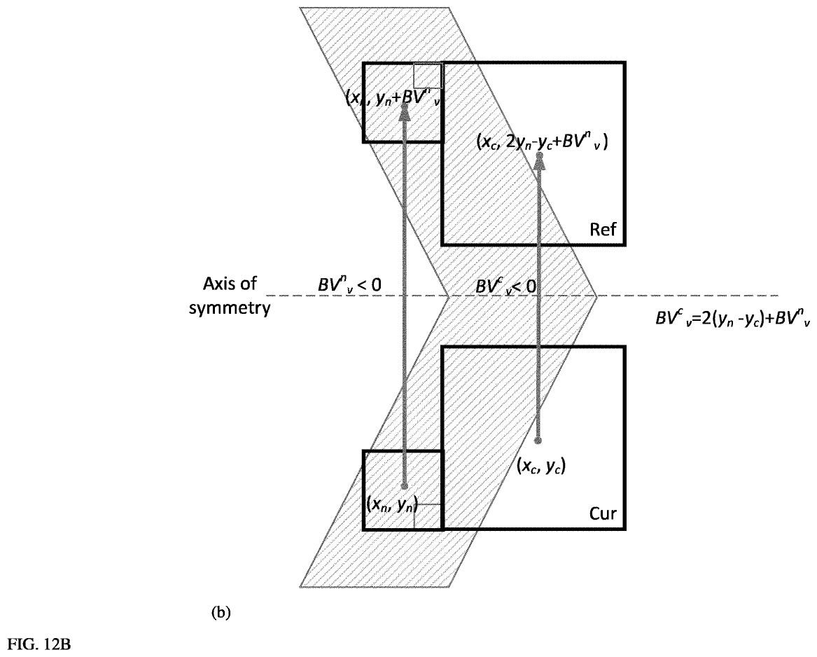

FIG. 12A and FIG. 12B show an illustration of BV adjustment for (a) horizontal flip as shown in FIG. 12A, and (b) vertical flip as shown in FIG. 12B.

To better utilize the symmetry property, a flip-aware BV adjustment approach is applied to refine the block vector candidate. For example, as shown in FIG. 12A and FIG. 12B, (xnbr, ynbr) and (xcur, ycur) represent the coordinates of the center sample of the neighbouring block and the current block, respectively, BVnbr and BVcur denotes the BV of the neighbouring block and the current block, respectively. Instead of directly inheriting the BV from a neighbouring block, the horizontal component of BVcur is calculated by adding a motion shift to the horizontal component of BVnbr (denoted as BVnbrh) in case that the neighbouring block is coded with a horizontal flip, i.e., BVcurh=2(xnbr−xcur)+BVnbrh. Similarly, the vertical component of BVcur is calculated by adding a motion shift to the vertical component of BVnbr (denoted as BVnbrv) in case that the neighbouring block is coded with a vertical flip, i.e., BVcurv=2(ynbr−ycur)+BVnbrv

IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

As similarly stated above, block vector guided cross-component prediction uses non-local regions to improve the prediction performance of the cross-component model when intra block copy is used. If the co-located block in the reference channel is coded using intra block copy (IBC) method, the associated block vector (BV) is used for indicating the reference region for calculating the parameters of the cross-component prediction model.

When co-located region contains several blocks with associated block vectors the reference sample selection can be performed in multiple ways. Reference samples should also reflect the intensity distribution of samples in the co-located block. Poorly selected reference samples directly lead to impaired performance in cross-component prediction.

Example embodiments of the invention provides several improvements to block vector guided cross-component prediction. The improvements deal with reference sample selection, handling of multiple block vectors in co-located area, handling of overlapping reference samples, robust reference sample selection based on co-located luminance sample values,

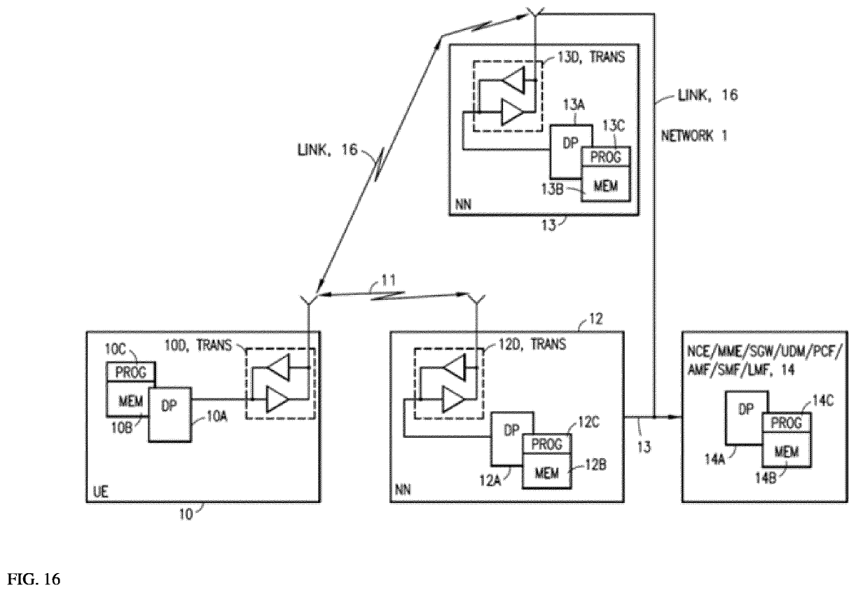

Before describing the example embodiments as disclosed herein in detail, reference is made to FIG. 16 for illustrating a simplified block diagram of various electronic devices that are suitable for use in practicing the example embodiments of this invention.

FIG. 16 shows a block diagram of one possible and non-limiting exemplary system in which the example embodiments may be practiced. In FIG. 16, a user equipment (UE) 10 is in wireless communication with a wireless network 1 or network, 1 as in FIG. 16. The wireless network 1 or network 1 as in FIG. 16 can comprise a communication network such as a mobile network e.g., the mobile network 1 or first mobile network as disclosed herein. Any reference herein to a wireless network 1 as in FIG. 16 can be seen as a reference to any wireless network as disclosed herein. Further, the wireless network 1 as in FIG. 16 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 16. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 16. The NN 12 may perform functionalities of an MME (Mobility Management Entity) or SGW (Serving Gateway), such as a User Plane Functionality, and/or an Access Management functionality for LTE and similar functionality for 5G.

The NN 13 can be for WiFi or Bluetooth or other wireless device associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 16 can be used for communication with the NN 12. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 16.

The one or more buses of the device of FIG. 16 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 16 shows a network nodes such as NN 12 and NN 13, any of these nodes may can incorporate or be incorporated into an eNodeB or eNB or gNB such as for LTE and NR, and would still be configurable to perform example embodiments.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR, 5G and/or any standards based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments. The one or more memories MEM 14B include computer program code PROG 14C. The one or more memories MEM 14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments.

It is noted that that the NN 12 and/or NN 13 and/or UE 10 can be configured (e.g. based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 16, as at least described below, can be co-located with UE 10 such as to be separate from the NN 12 and/or NN 13 of FIG. 16 for performing operations in accordance with example embodiments as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP 10, DP 12A, DP 13A, and/or DP 14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP 10, DP 12A, DP 13A, and DP 14A may be of any type suitable to the local technical environment, and may include one or more of general purpose computers, special purpose computers, microprocessors, digital signal processors (DSPs) and processors based on a multi-core processor architecture, as non-limiting examples. The processors DP 10, DP 12A, DP 13A, and DP 14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, example embodiments of the invention provides several improvements to block vector guided cross-component prediction. The improvements deal with reference sample selection, handling of multiple block vectors in co-located area, handling of overlapping reference samples, robust reference sample selection based on co-located luminance sample values, etc.

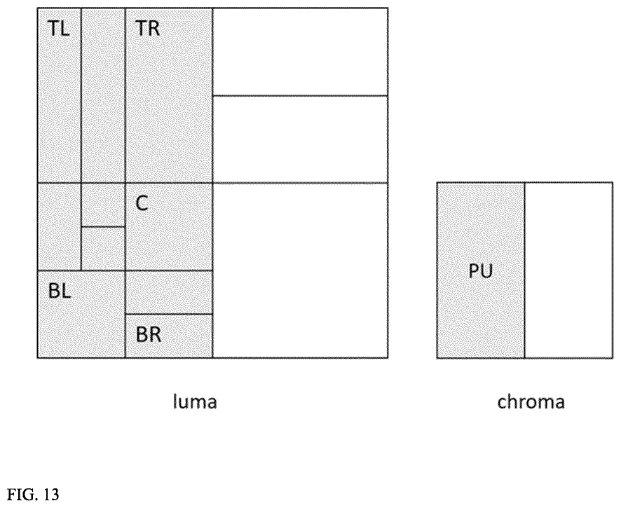

In an embodiment the reference area for cross-component model derivation may be determined using all available block vectors in the co-located luma coding units or prediction units (an example is illustrated in FIG. 13). FIG. 13 a chroma PU and co-located luma PUs.

In an embodiment the reference area for cross-component model derivation may be determined using only a subset of available block vectors in the co-located luma PUs (as illustrated in FIG. 13). For example, only C, TL, TR, BL and BR might be considered. The choice of the subset can be either inferred based on local properties such as PU size and shape, or it can be signalled by the encoder to the decoder.

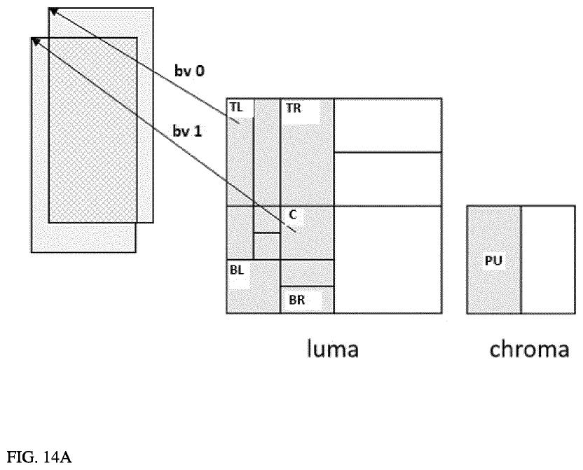

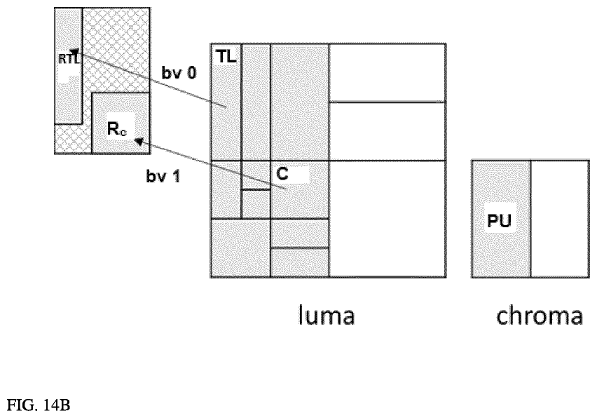

In an embodiment when multiple block vectors are available in the co-located luma PUs the reference sample area can be derived so that redundant overlapping areas are discarded. FIG. 14A shows two block vectors from co-located coding units C and TL pointing to different reference sample areas. The overlapping area (marked with a pattern) will be considered only once. For example, as illustrated in FIG. 14A, when two or more block vectors point to the same reference samples the overlapping area (marked with a pattern) will be considered only once. In addition to deriving more accurate cross-component prediction model, removing redundant overlapping samples may also reduce the computational complexity of the parameter calculation especially in the decoder side.

In an embodiment when multiple block vectors are available in the co-located PUs, the average of the block vectors may be used as the block vector pointing to the reference samples.

In an embodiment based on the previous embodiment the average may be applied only when the block vector difference is considered small enough.

In an embodiment based on the previous embodiments the average may be calculated as a weighted average based on the sizes of the co-located PUs so that the block vectors of larger PUs are assigned larger weights. Alternatively, the average can be calculated based on a fixed grid of block vectors. For example, each 4×4 block in the co-located block with a block vector may be identified and average of those block vectors can be determined to be the average block vector used to determine the location of the reference samples.

In an embodiment when multiple block vectors are available in the co-located PUs, linear or nonlinear estimation can be used to derive the block pointing to the reference samples. For example, the median, minimum or maximum of the block vectors can be considered. The choice of the operator (median, minimum, maximum, etc.) can be same or different for the horizontal and vertical block vector components.

FIG. 14B shows two block vectors from co-located coding units C and TL pointing to maximum and minimum coordinates of a compound reference area defined by the co-located block vectors and co-located PU areas are used to determine the reference area.

In an embodiment as shown in FIG. 14B when multiple block vectors are available in the co-located PUs, the maximum and minimum coordinates of a compound reference area defined by the co-located block vectors and co-located PU areas are used to determine the reference area. For example, the reference area can be determined to have its left border at the minimum horizontal coordinate of the compound area, its right border at the maximum of the horizontal coordinate of the compound area. Similarly, the top and bottom borders of the reference area can be determined using the minimum and maximum vertical coordinates of the compound area. In the case the reference area created this way is larger or smaller than the PU itself, the dimension of the reference area can be scaled to match the dimensions of the PU.

In an embodiment when all co-located PUs do not have block vectors associated with them, temporary block vectors can be determined for those co-located PUs which do not have block vectors of their own. Such temporary block vectors can be determined, for example, by replicating block vectors of selected PUs in the reference channel, or by interpolating temporary block vectors from block vectors of selected PUs in the reference channel. The temporary block vectors can then be used to determine the reference area similarly to block vectors obtained directly from co-located PUs.

In an embodiment the block vectors in the co-located PUs and their spatial location in the co-located area can be used to interpolate or estimate a refined block vector. For example, a planar or quadratic model can be used to derive an additional block vector at the center of the co-located luma area. This could be done for example using a linear regression solver to do such estimation. The derived block vector is then used as a pointer to the reference samples for cross-component model derivation.

In an embodiment, when multiple block vectors are available in the co-located PUs, a template matching-based refinement mechanism may be used on to find the best matching reference block and the corresponding block vector. The template matching based refinement may use some or all of the samples in the co-located reference block and/or some or all of the neighboring reference samples in the current block.

According to the previous embodiment, the template-matching based refinement may use one or more of the available block vectors from the co-located PUs as initial block vectors in refinement search. Alternatively, or additionally, the initial block vector or vectors can be derived using other embodiments described herein.

In an embodiment when multiple block vectors are available in the co-located PUs, the chroma PU can be divided into multiple cross-component models based on spatial location of the said co-located PUs.

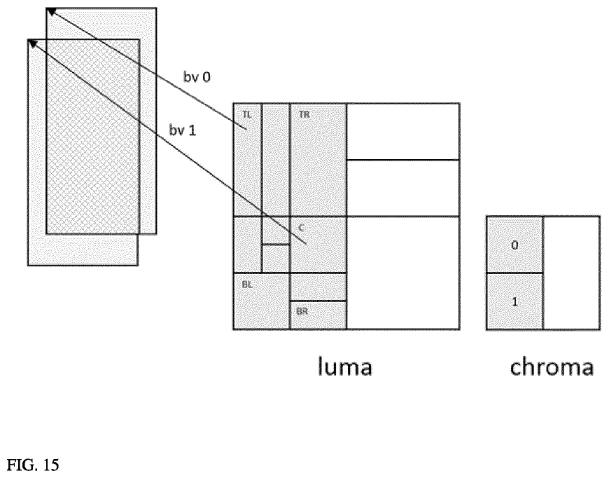

FIG. 15 shows two block vectors from co-located prediction units C and TL pointing to different reference sample areas. The chroma PU can be divided into two cross-component models (0 and 1) based on the spatial location of the PUs to which the block vectors (bv 0 and bv 1) belong.

For example, as shown in FIG. 15, the block vector 0 is used to derive the cross-component model of the upper half of the chroma PU (marked with 0) and reciprocally the block vector 1 is used to derive the cross-component model for the lower half of the chroma PU (marked with 1).

In an embodiment, when multiple block vectors are available in the co-located PUs, multiple cross-component models may be calculated using the multiple BVs. Then the final prediction may be obtained by combining the multiple predictions. The weights for combining the multiple predictions may be defined in the codec specifications or the weights or an identifier index of weights could be signalled in the bitstream, or they could be calculated in the decoder side based on the block information such sample reconstructed samples, block size, etc.

In an embodiment, the samples' statistics of the co-located block may be used for pruning the training samples in the reference block pointed by the block vector(s). For example, the minimum and maximum intensity values of samples in co-located block may be determined and used for the pruning in such a way that the samples in the minimum and maximum intensity range are considered for the parameter calculation or training the cross-component prediction model. The calculated minimum and maximum intensity values may be extended by a delta value from the lower bound and upper bound of the range to provide a larger intensity range for training. The delta value may be fixed, or it could be determined by the calculated minimum and maximum values. For example, it could be a certain percentage of the minimum and/or maximum values. In another example, the delta value to be used for extending the lower and upper bounds could be difference of minimum and maximum intensity values, or it could be a scaled version of the difference of minimum and maximum intensity values of the co-located block samples.

In an embodiment, the cross-component model type may be determined based on the distribution of samples from the co-located block and or reference block pointed by the block vector. For example, the decision whether to use single-model or multi-model prediction may be done based on the distribution of the samples with regard to the classification parameter of the cross-component model. The cross-component models usually use mean value of the training samples as classification parameter for calculating multiple models. When the ratio of samples for models, based on the classification parameter, is not well distributed, then the single-model variant may be determined. Alternatively, when the ratio of samples for models, based on the classification parameter, is well distributed, then a multi-model variant may be determined for cross-component prediction. The said ratio of samples may be pre-defined or signalled in the bitstream.

According to previous embodiment, the model type may be determined by other parameters in addition to or instead of minimum and maximum values. For example, mean value of the samples may be used. Samples from that fall into a certain intensity distance of the mean value from lower and upper bounds may be used for calculating the parameters. The intensity distance for determining the lower bound and upper bound may be the same or they may differ. The intensity distance may be defined as a certain percentage of the mean value. The intensity distance value or its indicator may be signalled in the bitstream.

In an embodiment, when multiple block vectors are available in the co-located PUs, the reference block for model derivation is determined by finding the best matching area to the co-located block in reference channel. The one or more of the available block vectors may be used in the search process. The search process best matching area may use cost calculation metrics such as sum of absolute differences (SAD), sum of squared error (SSE), sum of transform differences (SATD) or any other metric.

In another embodiment, one or more of correlation metrics may be used for selecting the samples from reference area that the block vector of the co-located PU is pointing at. For example, a correlation coefficient may be used as distortion metric as proposed earlier.

Below are the Details of how to Use Correlation Coefficient for Selecting the Most Correlated Samples with the Co-Located Block in Reference Channel:

Let us consider two signals X and Y both of length n. We now list five sums based on X and Y,

$${S}_{x} = Σ X$$

$${S}_{y} = Σ Y$$

$${S}_{xx} = Σ XX$$

$${S}_{yy} = Σ YY$$

$${S}_{xy} = Σ XY$$

and the Pearson correlation coefficient can be expressed as,

$$P ( X , Y ) = \frac{n {S}_{xy} - {S}_{x} {S}_{y}}{\sqrt{( n {S}_{xx} - {S}_{x} {S}_{x} ) ( n {S}_{yy} - {S}_{y} {S}_{y} )}} .$$

The denominator in the above equation (product of standard deviations of X and Y) normalizes the covariance of X and Y into [−1,1] range therefore making P useful for evaluating correlation between X and multiple Y's. For integer arithmetic we may use,

$${P}_{i n t} ( X , Y ) = \frac{( ( n {S}_{xy} - {S}_{x} {S}_{y} ) * ( n {S}_{xy} - {S}_{x} {S}_{y} ) ) << bitshift}{( n {S}_{xx} - {S}_{x} {S}_{x} ) ( n {S}_{yy} - {S}_{y} {S}_{y} )}$$

where bitshift is selected based on the required precision. Compared to P(X, Y) the quadratic behaviour of Pᵢₙₜ(X, Y) will preserve the sorting/ranking of the correlation coefficients but the magnitudes will decrease more rapidly.

We define the correlation cost as,

$$C ( X , Y ) = abs ( P ( X , Y ) ) ,$$

where larger values of C indicate better match. Many existing coding tools, such as VVC, perform motion compensation and template matching by minimizing SSE or SAD using integer arithmetic. We can easily insert correlation cost into said procedure by considering,

$$\hat{C} ( X , Y ) = - abs ( P ( X , Y ) ) ,$$

and for cases where negative distortion is not allowed, we can use,

$$\hat{C} ( X , Y ) = MAX\_INT - abs ( P ( X , Y ) ) ,$$

$$or$$

$$\hat{C} ( X , Y ) = MAX\_UINT - abs ( P ( X , Y ) ) ,$$

depending on the case.

The described process may iterate over different areas pointed by block vectors from co-located PUs and the area that results in highest correlation is used for calculating the cross-component prediction model.

Instead of or in addition to using different block vectors, a refinement process may be applied to one or more of the co-located block vectors from co-located PUs. The refinement process may add a delta to the initial block vector in either or both directions of the BV and calculate the correlation cost for the area associated by the refined BV. The best area and BV are then selected and used for calculating the parameters of the cross-component prediction.

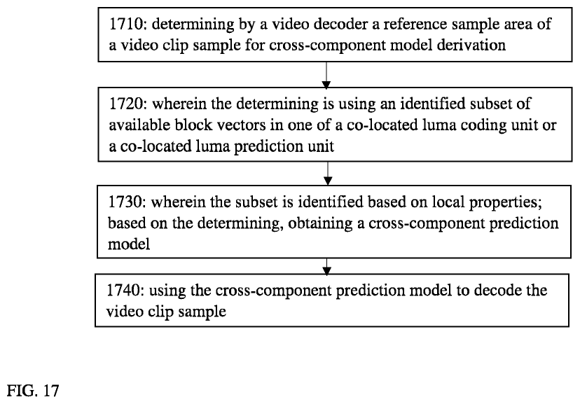

FIG. 17 illustrates operations which may be performed by a device such as, but not limited to, a device (e.g., the UE 10 as in FIG. 16). As shown in step 1710 of FIG. 17 there is determining by a video decoder a reference sample area of a video clip sample for cross-component model derivation. As shown in step 1720 of FIG. 17 wherein the determining is using an identified subset of available block vectors in one of a co-located luma coding unit or a co-located luma prediction unit. As shown in step 1730 of FIG. 17 wherein the subset is identified based on local properties. As shown in step 1740 of FIG. 17 there is, based on the determining, obtaining a cross-component prediction model. Then as shown in step 1750 of FIG. 17 there is using the cross-component prediction model to decode the video clip sample.

In accordance with the example embodiments as described in the paragraph above, wherein the local properties comprise at least one of a prediction unit size or prediction unit shape.

In accordance with the example embodiments as described in the paragraphs above, wherein the at least one of a prediction unit size or shape is predetermined by the video decoder or received from a video encoder.

In accordance with the example embodiments as described in the paragraphs above, wherein the reference sample area is an intra block copy reference area.

In accordance with the example embodiments as described in the paragraphs above, wherein the reference sample area is determined based on more than one block area being available in at least one prediction unit of the co-located luma.

In accordance with the example embodiments as described in the paragraphs above, wherein the determining comprises the reference sample area is derived so that overlapping areas or redundant areas are discarded.

In accordance with the example embodiments as described in the paragraphs above, wherein an average of the available block vectors are used as a block vector pointing to the reference sample area.

In accordance with the example embodiments as described in the paragraphs above, wherein the block vector is pointing to the reference sample area when a block vector size difference is below a threshold.

In accordance with the example embodiments as described in the paragraphs above, wherein the average may be calculated as a weighted average based on a size of the one of a co-located luma coding unit or a co-located luma prediction unit.

In accordance with the example embodiments as described in the paragraphs above, wherein weights are assigned to block vectors of the at least one prediction unit based on a size of a prediction unit of the at least one prediction unit.

In accordance with the example embodiments as described in the paragraphs above, wherein the average is calculated based on a fixed grid of block vectors.

In accordance with the example embodiments as described in the paragraphs above, wherein at least one of linear or non-linear estimation is used to derive the block vector pointing to the reference sample area.

In accordance with the example embodiments as described in the paragraphs above, wherein based on the more than one block area, a maximum and minimum coordinate of a compound reference area defined by co-located vectors and co-located prediction unit areas is used to determine the reference sample area.

In accordance with the example embodiments as described in the paragraphs above, wherein based on dimensions of the reference sample area being a different than the at least one prediction unit the apparatus is caused to scale a dimension of the reference sample area to match a dimension of the at least one prediction unit.

In accordance with the example embodiments as described in the paragraphs above, there is identifying temporary block vectors for co-located prediction units that do not have associated block vectors; and using the temporary block vectors to determine at least one of a reference sample area or block vectors obtained directly from co-located prediction units.

In accordance with the example embodiments as described in the paragraphs above, wherein a spatial location of block vectors in a co-located area of the one of a co-located luma coding unit or a co-located luma prediction unit is used to interpolate or estimate a block vector pointing to reference sample of the reference sample area for the cross-component model derivation.

In accordance with the example embodiments as described in the paragraphs above, wherein based on multiple block vectors being available in the co-located prediction unit areas, a template matching-based refinement mechanism is used to find at least one of a matching reference area block or a corresponding block vector of the identified subset of available block vectors.

In accordance with the example embodiments as described in the paragraphs above, wherein template matching-based refinement mechanism uses at least one sample of at least one of a co-located reference area block or at least one neighboring reference sample in a current block.

In accordance with the example embodiments as described in the paragraphs above, wherein based on multiple block vectors being available in the co-located prediction unit areas, a chroma prediction unit is divided into multiple cross-component models based on spatial location of the said co-located prediction unit.

In accordance with the example embodiments as described in the paragraphs above, wherein a block vector 0 is used to derive a cross-component model of an upper half of a chroma prediction unit marked with 0 and use a block vector 1 to derive a cross-component model for a lower half of a chroma prediction unit marked with 1.

In accordance with the example embodiments as described in the paragraphs above, wherein based on multiple block vectors being available in the co-located prediction unit areas, multiple predictions are made of multiple cross-component models using multiple block vectors; and a final prediction is obtained by combining the multiple predictions.

In accordance with the example embodiments as described in the paragraphs above, wherein weights for combining the multiple predictions can be one of defined in codec specifications or an identifier index of weights signalled to the video decoder, or calculated in the decoder side based on block information comprising reconstructed samples and a block size.

In accordance with the example embodiments as described in the paragraphs above, wherein statistics of a co-located block of the more than one block area are used for pruning training samples in a reference area block of the reference sample area pointed to by at least one block vector.

In accordance with the example embodiments as described in the paragraphs above, wherein minimum and maximum intensity values of samples in co-located block are determined and used for pruning in such a way that samples in a minimum intensity range and a maximum intensity range are considered for at least one of parameter calculation or training a cross-component prediction model.

In accordance with the example embodiments as described in the paragraphs above, wherein the minimum intensity values and the maximum intensity values are extended by a delta value from the lower bound and upper bound of the maximum intensity range to provide a larger range for training, and wherein the delta value is one of fixed or is determined by the minimum intensity values and the maximum intensity values.

In accordance with the example embodiments as described in the paragraphs above, wherein the cross-component model type is determined based on the distribution of samples from the co-located block and or reference block pointed by the block vector.

In accordance with the example embodiments as described in the paragraphs above, wherein for a case a ratio of samples for models based on the classification parameter is distributed, a multi-model variant is determined for the cross-component prediction model, wherein said ratio of samples is one of pre-defined or signalled to the decoder.

In accordance with the example embodiments as described in the paragraphs above, wherein the model type is determined by other parameters in addition to or instead of minimum and maximum values, wherein the other parameters comprises a mean value of samples used, wherein the mean value comprises lower and upper bounds based on intensity distance that is used for the parameter calculation, and wherein the intensity distance is one of pre-defined or signalled to the decoder.

In accordance with the example embodiments as described in the paragraphs above, wherein based on multiple block vectors being available in the co-located prediction unit area, a reference block for model derivation is determined by finding a matching area to a co-located block in a reference channel.

In accordance with the example embodiments as described in the paragraphs above, wherein, one or more of correlation metrics are used for selecting samples from the reference sample area that a block vector of a co-located prediction unit is pointing at.

A non-transitory computer-readable medium (MEM 12B as in FIG. 16) storing program code (PROG 10C as in FIG. 16), the program code executed by at least one processor (DP 10A and/or DP 10F as in FIG. 16) to perform the operations as at least described in the paragraphs above.

In accordance with an example embodiment of the invention as described above there is an apparatus comprising: there is means for determining (one or more transceivers 12D and/or 13D; MEM 12B and/or MEM 13B; PROG 12C and/or PROG 13C; and DP 12A and/or DP 13A as in FIG. 16) by a video decoder a reference sample area of a video clip sample for cross-component model derivation, wherein the determining is using an identified subset of available block vectors in one of a co-located luma coding unit or a co-located luma prediction unit, and wherein the subset is identified (one or more transceivers 12D and/or 13D; MEM 12B and/or MEM 13B; PROG 12C and/or PROG 13C; and DP 12A and/or DP 13A as in FIG. 16) based on local properties; means, based on the determining, for obtaining (one or more transceivers 12D and/or 13D; MEM 12B and/or MEM 13B; PROG 12C and/or PROG 13C; and DP 12A and/or DP 13A as in FIG. 16) a cross-component prediction model; and means for using (one or more transceivers 12D and/or 13D; MEM 12B and/or MEM 13B; PROG 12C and/or PROG 13C; and DP 12A and/or DP 13A as in FIG. 16) the cross-component prediction model to decode the video clip sample.

In the example aspect of the invention according to the paragraph above, wherein at least the means for determining, identifying, and using comprises a non-transitory computer readable medium [MEM 12B and/or MEM 13B as in FIG. 5] encoded with a computer program [PROG 12C and/or PROG 13C] executable by at least one processor [DP 12A and/or DP 13A as in FIG. 16].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following: hardware-only circuit implementations (such as implementations in only analog and/or digital circuitry); combinations of hardware circuits and software, such as (as applicable): a combination of analog and/or digital hardware circuit(s) with software/firmware; and any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and (c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1.-31. (canceled)

32. An apparatus, comprising:
at least one processor; and
at least one memory storing instructions, that when executed by the at least one processor, cause the apparatus at least to:
determine by a video decoder a reference sample area of a video clip sample for cross-component model derivation,
wherein the determining comprises using an identified subset of available block vectors in one of a co-located luma coding unit or a co-located luma prediction unit, and
wherein the subset is identified based on local properties;
based on the determining, obtain a cross-component prediction model; and
use the cross-component prediction model to decode the video clip sample.

33. The apparatus of claim 32, wherein the local properties comprise at least one of a prediction unit size or a prediction unit shape.

34. The apparatus of claim 32, wherein the reference sample area is determined based on more than one block area being available in at least one prediction unit of the co-located luma prediction unit.

35. The apparatus of claim 34, wherein the determining comprises deriving the reference sample area so that overlapping reference sample areas or redundant reference sample areas are discarded.

36. The apparatus of claim 32, wherein an average of available block vectors are used as a block vector pointing to the reference sample area.

37. The apparatus of claim 36, wherein the average is calculated as a weighted average based on a size of the one of the co-located luma coding unit or the co-located luma prediction unit, wherein weights are assigned to block vectors of the at least one prediction unit based on a size of a prediction unit of the at least one prediction unit.

38. The apparatus of claim 36, wherein at least one of linear or non-linear estimation is used to derive the block vector pointing to the reference sample area.

39. The apparatus of claim 36, wherein based on the more than one block area, a maximum and a minimum coordinate of a compound reference area, defined by co-located vectors and co-located prediction unit areas, is used to determine the reference sample area.

40. The apparatus of claim 32, wherein the at least one memory storing instructions is executed by the at least one processor to cause the apparatus to:
identify temporary block vectors for co-located prediction units that do not have associated block vectors; and
use the temporary block vectors to determine at least one of a reference sample area or block vectors obtained directly from co-located prediction units.

41. The apparatus of claim 36, wherein when multiple block vectors are available in the co-located prediction unit areas, a chroma prediction unit is divided into multiple cross-component models based on spatial location of the co-located prediction unit areas.

42. The apparatus of claim 32, wherein, one or more of correlation metrics are used for selecting samples from the reference sample area that a block vector of a co-located prediction unit is pointing at.

43. A method, comprising:
determining by a video decoder a reference sample area of a video clip sample for cross-component model derivation,
wherein the determining is using an identified subset of available block vectors in one of a co-located luma coding unit or a co-located luma prediction unit, and
wherein the subset is identified based on local properties;
based on the determining, obtaining a cross-component prediction model; and
using the cross-component prediction model to decode the video clip sample.

44. The method of claim 43, wherein the local properties comprise at least one of a prediction unit size or a prediction unit shape.

45. The method of claim 43, wherein the reference sample area is determined based on more than one block area being available in at least one prediction unit of the co-located luma prediction unit.

46. The method of claim 45, wherein the determining comprises deriving the reference sample area so that overlapping reference sample areas or redundant reference sample areas are discarded.

47. The method of claim 43, wherein an average of available block vectors are used as a block vector pointing to the reference sample area.

48. The method of claim 47, wherein the average is calculated as a weighted average based on a size of the one of the co-located luma coding unit or the co-located luma prediction unit, wherein weights are assigned to block vectors of the at least one prediction unit based on a size of a prediction unit of the at least one prediction unit.

49. The method of claim 47, wherein at least one of linear or non-linear estimation is used to derive the block vector pointing to the reference sample area.

50. The method of claim 47, based on the more than one block area, a maximum and minimum coordinate of a compound reference area, defined by co-located vectors and co-located prediction unit areas, is used to determine the reference sample area.

51. The method of claim 43, comprising:
identifying temporary block vectors for co-located prediction units that do not have associated block vectors; and
using the temporary block vectors to determine at least one of a reference sample area or block vectors obtained directly from co-located prediction units.
